(19) United States
(12) Patent Application Publication
(10) Pub. No.: US 2012/0249758 A1
(43) Pub. Date: Oct. 4, 2012

(54) ELECTRIC APPARATUS AND CONTROL METHOD OF INDICATOR

(75) Inventors: Ryo SAITO, Tokyo (JP); Tomohiro WADA, Tokyo (JP)

(73) Assignee: KABUSHIKI KAISHA TOSHIBA, Tokyo (JP)

(21) Appl. No.: 13/427,535

(22) Filed: Mar. 22, 2012

(30) Foreign Application Priority Data
Mar. 31, 2011 (JP) 2011-080073

(51) Int. Cl. H04N 13/04; H04N 5/225; H04N 7/18

(52) U.S. Cl. 348/54; 348/78; 348/262; 348/E05.024; 348/E07.085; 348/E13.026

(57) ABSTRACT

According to one embodiment, an electric apparatus has a camera or a plurality of cameras, an indicator, and a first controller. The first controller is configured to switch an indication of the indicator according to whether the camera performs photographing and whether to recognize a user's eye based on an image photographed by the camera.

### CROSS REFERENCE TO RELATED APPLICATIONS

This application is based upon and claims the benefit of priority from the prior Japanese Patent Application No. 2011-80073, filed on Mar. 31, 2011, the entire contents of which are incorporated herein by reference.

### FIELD

Embodiments described herein relate generally to an electric apparatus and a control method of an indicator.

### BACKGROUND

Electric apparatuses such as personal computers have some indicators indicative of the operating status of the electric apparatus. For example, a personal computer with a camera often has an LED (Light Emitting Diode) for indicating that the camera is activated. If an indicator is used for indicating one operating status, a lot of parts are necessary, which may deteriorate the design quality.

### BRIEF DESCRIPTION OF THE DRAWINGS

FIG. 1 is a perspective view of a personal computer 100 according to a first embodiment.

FIG. 2 is a schematic block diagram showing an example of a system configuration for controlling the indicator 50.

FIG. 3 is a flowchart showing an example of processing operations of the controller 200.

FIG. 4 is a table showing a relationship between the indication of the indicator 50 and the operation status of the personal computer 100.

FIG. 5 is a perspective view of a personal computer 101 according to a second embodiment.

FIG. 6 is a schematic block diagram showing an example of a system configuration for controlling the indicator 50.

FIG. 7 is a flowchart showing an example of processing operations of the controller 201.

FIG. 8 is a table showing a relationship between the indication of the indicator 50 and the operation status of the personal computer 101.

FIG. 9 is a perspective view of a personal computer 102 according to a third embodiment.

FIG. 10 is a schematic block diagram showing an example of a system configuration for controlling the indicator 50.

FIG. 11 is a flowchart showing an example of processing operations of the controller 202.

FIG. 12 is a table showing a relationship between the indication of the indicator 50 and the operation status of the personal computer 102.

### DETAILED DESCRIPTION

In general, according to one embodiment, an electric apparatus has a camera or a plurality of cameras, an indicator, and a first controller. The first controller is configured to switch an indication of the indicator according to whether the camera performs photographing and whether to recognize a user's eye based on an image photographed by the camera.

Embodiments will now be explained with reference to the accompanying drawings. The following embodiments will focus on a personal computer as a representative of an electric apparatus. Note that, a general explanation on the personal computer will be omitted, and characteristics of the present embodiments will be described in detail.

### First Embodiment

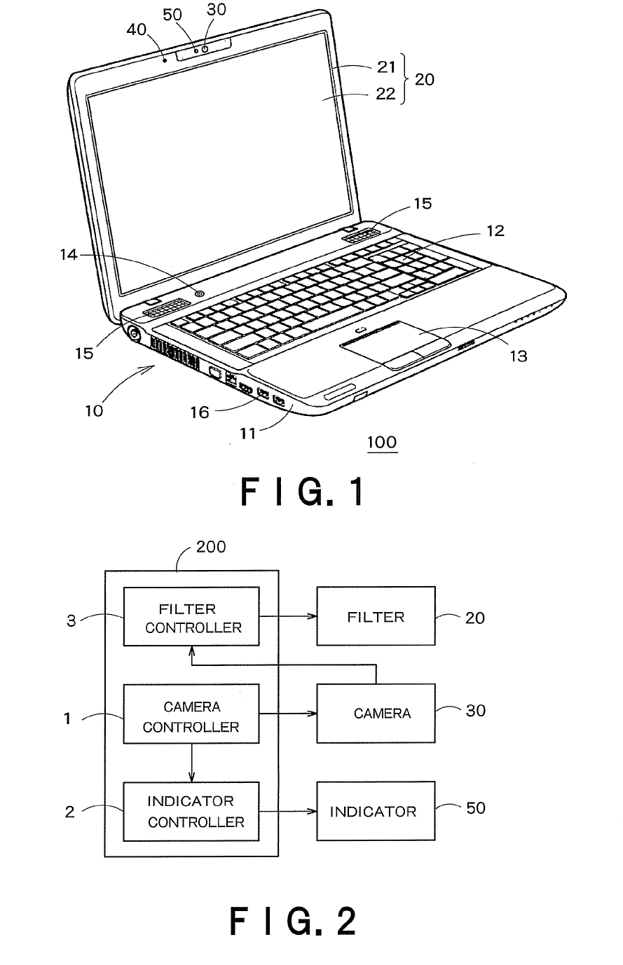

FIG. 1 is a perspective view of a personal computer 100 according to a first embodiment. The personal computer 100 has a computer body 10, a display unit 20, a camera 30, a microphone 40 and an indicator 50.

The computer body 10 has a thin box-shaped case 11. On the case 11 arranged are a keyboard 12, a touch pad 13 and power button 14 which receive the user's operation, speakers 15, USB (Universal Serial Bus) terminals 16 and so on. Furthermore, in the case 11 arranged are a CPU (Central Processing Unit), a memory, an HDD (Hard Disk Drive) and an optical disk drive and so on (not shown).

The keyboard 12 is an input device for generating signals indicative of operation characteristics such as character-entering and icon-selection. The touch pad 13 is a pointing device for generating signals indicative of operation characteristics such as screen-transition, cursor-motion and icon-selection. The power button 14 is a switch for on/off-controlling the power of the electric apparatus 100.

The CPU mounted in the computer body 10 executes a program stored in the hard disk to reproduce video signals stored in, for example, the hard disk, an optical disk such as a DVD (Digital Versatile Disk), an HD DVD (High Definition DVD), a BD (Blu-ray Disk) inserted in the optical disk device, or a USB storage device connected to the USB terminal 16.

In the present embodiment, the computer body 10 outputs multiple parallax images viewed from different viewpoints to the display unit 20 so that the user can view the image stereoscopically without glasses. When depth information is included in the video signal in advance, the parallax images can be generated using the depth information. On the other hand, when the depth information is not included, the depth information can be calculated by analyzing the video signal to generate the parallax images. Furthermore, it is enough that at least two parallax images for right and left eyes are generated. However nine parallax images viewed from nine viewpoints arranged in a horizontal direction may be generated in order to display a three-dimensional image more naturally.

The computer body 10 has a controller (not shown), which will be described in detail below, for controlling the display unit 20, the camera 30 and the indicator 50. The controller is, for example, stored in the hard disk as a computer program.

The display unit 20 is rotatably attached on the computer body 10 via a hinge (not shown). The display unit 20 has a liquid crystal panel (display) 21 and a filter (outputting module) 22. The reproduced multiple parallax images are simultaneously displayed on the liquid crystal panel 21. The filter 22 is, for example, a liquid crystal filter, and controls an output direction from the liquid crystal panel 21 by deflecting the liquid crystal material.

In a case of autostereoscopic display, the image may not be viewed stereoscopically according to a position of the user. Therefore, the filter 22 is arranged facing the liquid crystal panel 21, and outputs the parallax images displayed on the liquid crystal panel 21 to a specific direction. That is, the filter 22 outputs one of the multiple parallax images to the right eye of the user, and another one of the multiple parallax images to the left eye. By viewing different parallax images with the right eye and the left eye, the user can view the image stereoscopically. The output direction of the filter 22 can be controlled by the controller, which will be described below.

The camera 30 is arranged above the display unit 20, for example. In order to track the right eye and the left eye of the user to recognize them (eye-tracking) to control the output direction of the filter 22, the camera 30 photographs a predetermined area to provide the photographed image to the controller. Furthermore, the image photographed by the camera 30 can be displayed on the liquid crystal panel 21, stored in the hard disk in the computer body 10 and/or sent to other personal computers through network, in addition to the eye-tracking.

The microphone 40 picks up the sound on a predetermined area cooperating with the camera 30, for example.

The indicator 50 is provided near the camera 30 to indicate an operation status of the camera 30 in order to improve the security. The indicator 50 has, for example, an LED. One of the characteristics of the present embodiment is that the indicator 50 is a multi-purpose indicator indicative of both of whether or not the camera 30 is performing the photographing and whether or not the eye-tracking is performed.

The camera 30 and the indicator 50 are formed as a camera module, are connected to the computer body 10 through a USB cable (not shown) inside the display unit 20, and are controlled by the controller.

FIG. 2 is a schematic block diagram showing an example of a system configuration for controlling the indicator 50. The controller 200 has a camera controller 1 for controlling the camera 30, an indicator controller (first controller) 2 for controlling the indicator 50, and a filter controller (second controller) 3 for controlling the filter 22.

The camera controller 1 receives an instruction through the keyboard 12 and/or the touch pad 13 from the user to control turning on and off of the camera 30 and to control whether or not perform the eye-tracking. The indicator controller 2 controls the indicator 50 according to whether or not the camera 30 performs the photographing and whether or not the eye-tracking is performed. The filter controller 3 performs the eye-tracking based on the image photographed by the camera 30, to control the filter 22 so that one of the multiple parallax images displayed on the liquid crystal panel 21 is outputted to the right eye of the user and another one is outputted to the left eye.

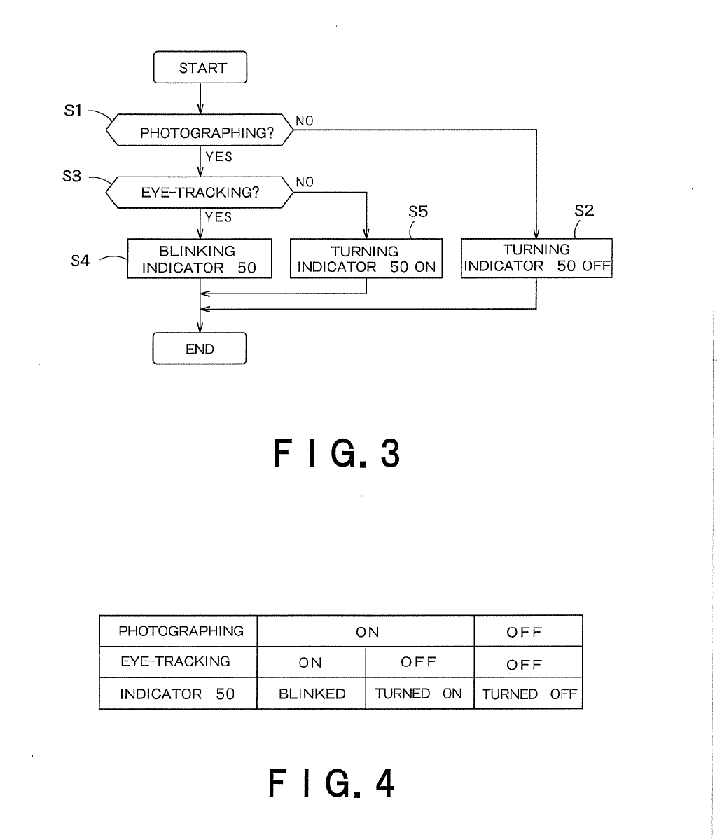

FIG. 3 is a flowchart showing an example of processing operations of the controller 200. FIG. 4 is a table showing a relationship between the indication of the indicator 50 and the operation status of the personal computer 100.

When the camera controller 1 does not turn the camera 30 on and the photographing is not performed (Step S1—NO), the indicator controller 2 turns the indicator 50 off (Step S2).

On the other hand, when the camera controller 1 turns on the camera 30 and the photographing is performed (Step S1—YES), and the filter controller 3 performs the eye-tracking (Step S3—YES), the indicator controller 2 blinks the indicator 50 (Step S4). Furthermore, the filter controller 3 controls the filter 22 based on the position of the user's eye recognized by the eye-tracking so that the user can view the image stereoscopically.

Furthermore, when the photographing is performed (Step S1—YES) but the eye-tracking is not performed (Step S3—NO), the indicator controller 2 turns the indicator 50 on (Step S5).

As stated above, in the first embodiment, the indicator controller 2 switches the indication of the indicator 50 taking into consideration not only whether or not the camera 30 performs the photographing but also whether or not the eye-tracking is performed. Therefore, the user can, as shown is FIG. 4, find out both of whether or not the camera 30 performs the photographing and whether or not the eye-tracking is performed from one indicator 50. Accordingly, the number of the parts can be reduced, thereby decreasing the cost and improving the design quality.

Note that, in the present embodiment, an example has been explained where the indicator 50 has one LED and has switchable three modes, that is, turned off, turned on and blinked. However, the brightness can be switched in accordance with Steps S2, S4 and S5 of FIG. 3, for example. Furthermore, the indicator 50 can have a plurality of LEDs emitting lights with colors different from each other to switch the indicator's color. These can be also combined.

### Second Embodiment

The personal computer 100 of the above first embodiment has one camera 30. On the other hand, a second embodiment which will be described below relates to a personal computer having a plurality of cameras and can perform stereo-photographing.

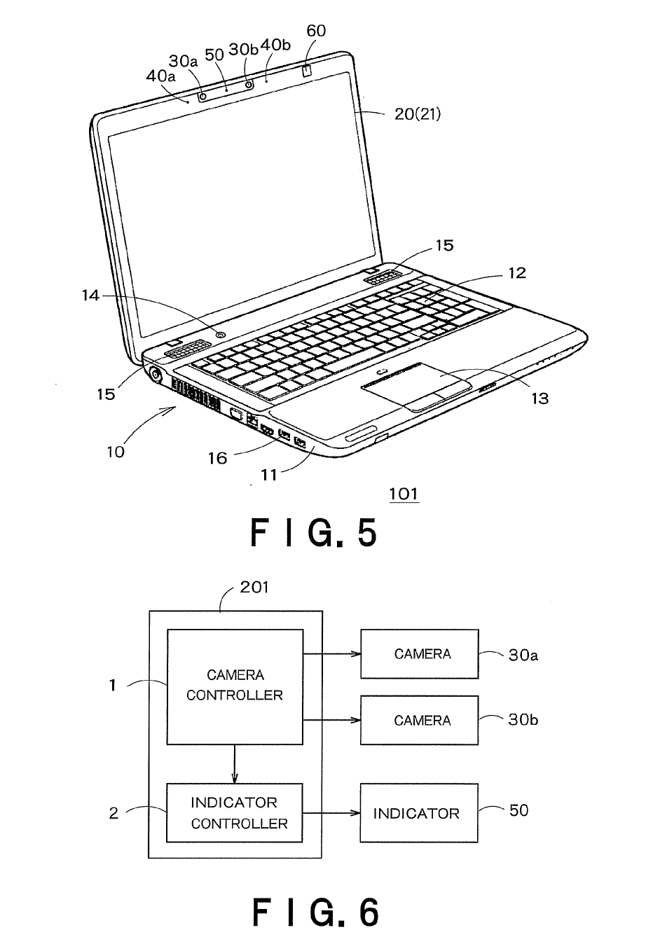

FIG. 5 is a perspective view of a personal computer 101 according to a second embodiment. In FIG. 5, components common to those of FIG. 1 have common reference numerals, respectively. Hereinafter, components different from FIG. 1 will be mainly described below.

The personal computer 101 has, different from the personal computer 100 of FIG. 1, two cameras 30a and 30b, two microphones 40a and 40b, and an infra-red ray transmitter (signal transmitter) 60. Furthermore, the display unit 20 does not have the filter 22.

The cameras 30a and 30b are arranged above the display unit 20 at the right side and the left side, respectively. By stereo-photographing the object by using the cameras 30a and 30b, the image photographed by the camera 30a as a parallax image for left eye and that photographed by the camera 30b as a parallax image for right eye can be displayed on the 21 or on other personal computer received the images stereoscopically, which can be used for television conference and so on. Similarly, two microphones 40a and 40b can store stereo sound.

Furthermore, in the present embodiment, it is assumed that the image is displayed stereoscopically not without glasses but with glasses having shutters. That is, the parallax image for right eye and that for left eye are displayed alternatively on the liquid crystal panel 21. Then, the infra-red ray transmitter 60 transmits an infra-red signal indicative of which parallax image is presently displayed to the user's glasses. According to the infra-red signal, when the parallax image for right eye is displayed, a shutter for right eye opens, while when the parallax image for left eye is displayed, a shutter for left eye opens. As a result, the user can view the parallax image for right eye with the user's right eye and that for left eye with the user's left eye, thereby viewing the image stereoscopically.

When the glasses are used, the user can view the image stereoscopically regardless of the user's position because the parallax image for right eye and that for left eye are displayed alternatively. Therefore, it is unnecessary to perform the eye-tracking and to provide the filter 22. Note that, not only the images photographed by the cameras 30a and 30b, but also parallax images generated from the video signal stored in the hard disk and so on can be displayed on the liquid crystal panel 21.

FIG. 6 is a schematic block diagram showing an example of a system configuration for controlling the indicator 50. The controller 201 has a camera controller 1 for controlling the cameras 30a and 30b, and an indicator controller 2 for controlling the indicator 50.

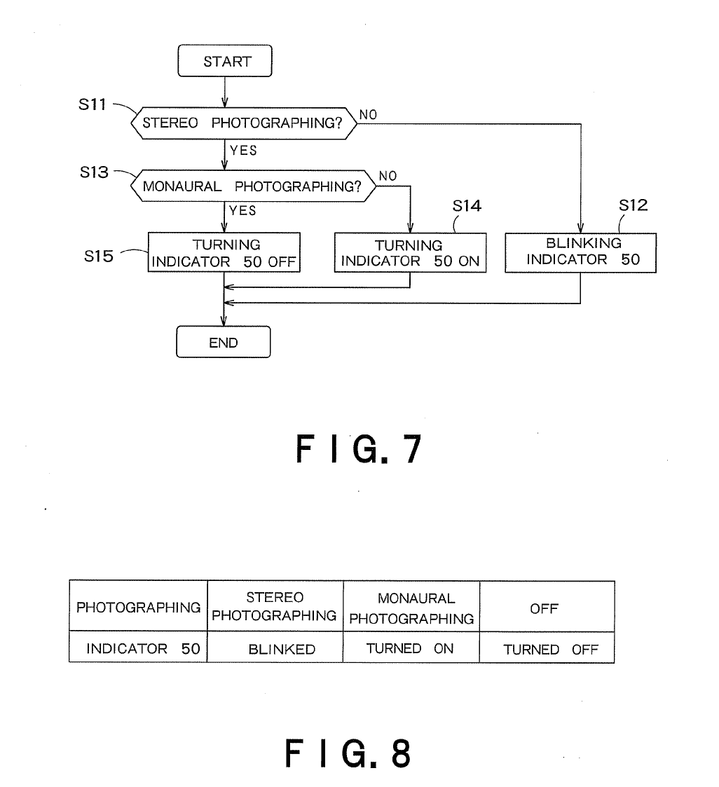

FIG. 7 is a flowchart showing an example of processing operations of the controller 201. FIG. 8 is a table showing a relationship between the indication of the indicator 50 and the operation status of the personal computer 101.

When the camera controller 1 turns both the cameras 30a and 30b on and the stereo-photographing is performed (Step S11—YES), the indicator controller 2 blinks the indicator 50 (Step S12). In this case, the stereo-photographed images can be stereoscopically displayed on the liquid crystal panel 21 and so on.

Furthermore, when the camera controller 1 turns one of the cameras 30a and 30b on and the monaural-photographing is performed (Step S11—NO, and S13—YES), the indicator controller 2 turns the indicator 50 on (Step S14).

When the camera controller 1 turns both the cameras 30a and 30b off not and the photographing is performed (Step S13—NO), the indicator controller 2 turns the indicator 50 off (Step S15).

As stated above, in the second embodiment, the indicator controller 2 switches the indication of the indicator 50 taking into consideration the number of cameras performing the photographing. Therefore, the user can find out whether or not the photographing is performed and whether the stereo-photographing or monaural-photographing is performed from one indicator 50.

In FIG. 5, an example is shown where the personal computer 101 has two cameras 30a and 30b. However, the personal computer 101 can have three or more cameras. In this case, the indication of the indicator controller 2 can switch the speed of blinking, brightness and/or color or the like according to the number of the cameras performing the photographing.

### Third Embodiment

In the second embodiment described above, images are displayed stereoscopically with glasses. On the other hand, in a third embodiment which will be described below, the personal computer has a plurality of cameras, and images are displayed auto-stereoscopically without glasses similar to the first embodiment.

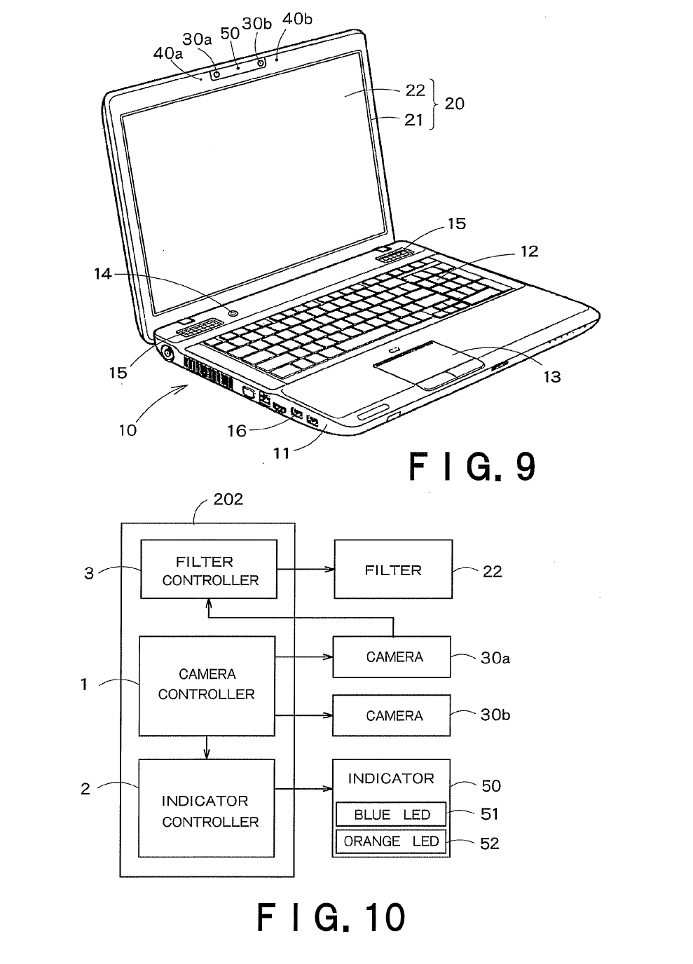

FIG. 9 is a perspective view of a personal computer 102 according to a third embodiment. The personal computer 102 has two cameras 30a and 30b, and two microphones 40a and 40b, similar to the second embodiment. Furthermore, the display unit 20 has the filter 22 and does not have the infra-red ray transmitter 60 similar to the first embodiment because the present embodiment assumes displaying the image stereoscopically without glasses.

Two cameras 30a and 30b performs the stereo-photographing to use the photographed images for three-dimensional display, and one of the image photographed by the camera 30a and that photographed by the camera 30b can be used to perform the eye-tracking. It is also possible to perform the stereo-photographing and not to perform the eye-tracking. Furthermore, the eye-tracking can be performed while the monaural-photographing is performed by one of the cameras 30a and 30b. In this case, the monaural-photographing can be performed by one of the cameras 30a and 30b, and the eye-tracking can be performed by using the image photographed by the other camera. Alternatively, the monaural photographed image can be used to perform the eye-tracking.

FIG. 10 is a schematic block diagram showing an example of a system configuration for controlling the indicator 50. The controller 202 has the camera controller 1 for controlling the cameras 30a and 30b, the indicator controller 2 for controlling the indicator 50, and the filter controller 3 for controlling the filter 22. Furthermore, the indicator 50 in the present embodiment has two LEDs which emit different colored light, for example, a blue LED 51 and an orange LED 52.

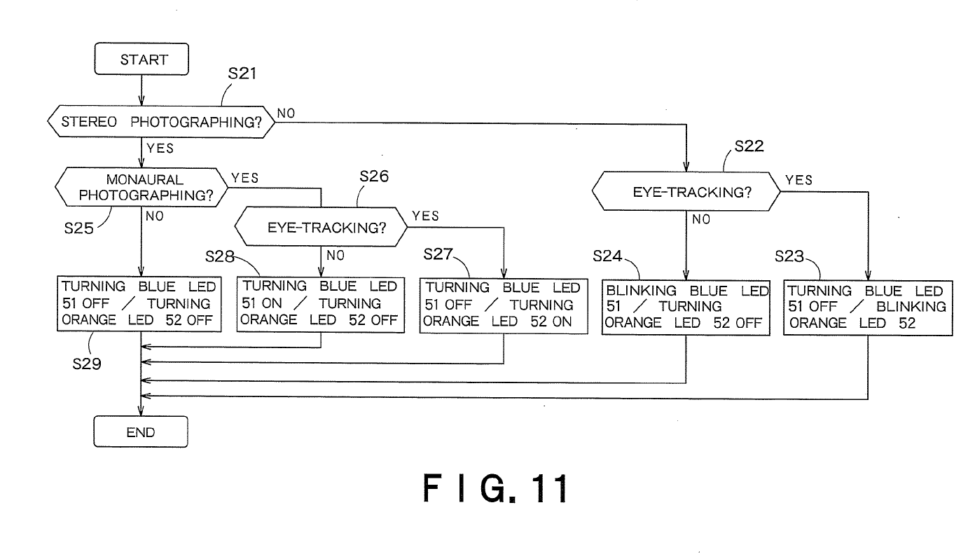

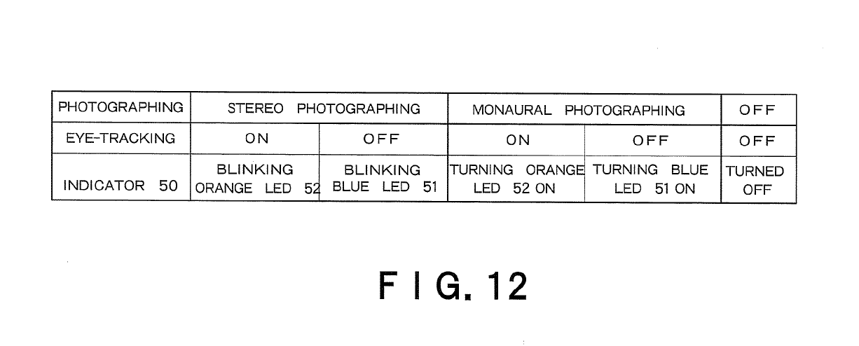

FIG. 11 is a flowchart showing an example of processing operations of the controller 202, and FIG. 12 is a table showing a relationship between the indication of the indicator 50 and the operation status of the personal computer 102.

When the camera controller 1 turns the both cameras 30a and 30b and the stereo-photographing is performed (Step S21—YES), and the filter controller 3 performs the eye-tracking (Step S22—YES), the indicator controller 2 turns the blue LED 51 of the indicator 50 off and blinks the orange LED 52 (Step S23). Furthermore, the filter controller 3 controls the filter 22 based on the position of the user's eye recognized by the eye-tracking so that the user can view the image stereoscopically.

When the stereo-photographing is performed (Step S21—YES) while the eye-tracking is not performed (Step S22—NO), the indicator controller 2 blinks the blue LED 51 and turns the orange LED 52 off (Step S24).

On the other hand, when the camera controller 1 turns one of the cameras 30a and 30b on and the monaural-photographing is performed (Step S21—NO and S25—YES), and the filter controller 3 performs the eye-tracking (Step S26—YES), the indicator controller 2 turns the blue LED 51 off and turns the orange LED 52 on (Step S27).

When the monaural-photographing is performed (Step S25—YES) while the eye-tracking is not performed (Step S26—NO), the indicator controller 2 turns the blue LED 51 on and turns the orange LED 52 off (Step S28).

When the camera controller 1 turns the cameras 30a and 30b off and the photographing is not performed (Step S25—NO), the indicator controller 2 turns the blue LED 51 and the orange LED 52 off (Step S29).

As shown in FIG. 12, the indicator 50 can indicate whether or not the eye-tracking is performed according to whether the lighting color is blue or orange, and can indicate whether the stereo-photographing is performed or the monaural stereo-photographing is performed according to whether the indicator 50 is lighting or blinking.

As stated above, in the third embodiment, the indication of the indicator 50 is switched according to whether or not the eye-tracking is performed in addition to the number of the cameras performing the photographing. Therefore, the user can know whether the stereo-photographing is performed or the monaural-photographing is performed, and whether or not the eye-tracking is performed from one indicator 50.

Although, in the above embodiments, the indication of the indicator is switched according to the control of the camera, additional information can be indicated by the indicator. For example, the indicator may indicate whether or not the personal computer operates in an “ecology-mode” (low power operation mode), where, in order to decrease the consumption power comparing to a normal mode, the time to become sleep mode is shortened and/or illumination lights are turned off. For example, in FIGS. 3 and 7, when the personal computer does not operate in the ecology-mode, a blue LED may be turned off, turned on and blinked, and when the personal computer operates in the ecology-mode, a green LED may be turned off, turned on and blinked.

At least a part of the controllers 200 to 202 explained in the above embodiments can be formed of hardware or software. When the controllers 200 to 202 is partially formed of the software, it is possible to store a program implementing at least a partial function of the controllers 200 to 202 in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the controllers 200 to 202 can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An electric apparatus comprising:
one or more cameras;
an indicator; and
a first controller configured to switch an indication of the indicator based on whether the camera is obtaining images and whether the apparatus recognizes a user's eye based on an image obtained by the camera.

2. The apparatus of claim 1 further comprising:
a display configured to display a plurality of parallax images;
an outputting module configured to output each of the displayed parallax images in a specific direction; and
a second controller configured to recognize the user's eye based on the image obtained by the camera and to control an output direction of the outputting module based on a position of the user's eye such that the parallax images displayed on the display are viewed stereoscopically.

3. The apparatus of claim 1, wherein the first controller is further configured to switch the indication of the indicator based on the number of the cameras obtaining images among the one or more cameras, and whether the apparatus recognizes the user's eye based on the image obtained by the camera.

4. The apparatus of claim 1, wherein the first controller is further configured to switch at least one of:
a color of the indicator,
a brightness of the indicator, and
an indication configuration, the indication configuration comprising on, off, and blinking.

5. The apparatus of claim 1, wherein the first controller is further configured to switch the indication of the indicator based on whether the apparatus operates in a low consumption power mode.

6. An electric apparatus comprising:
a plurality of cameras;
an indicator; and
a first controller configured to switch an indication of the indicator based on the number of cameras from the plurality of cameras that are obtaining images.

7. The apparatus of claim 6 further comprising:
a display configured to display images photographed by the plurality of cameras, each camera's image displayed independently from the images of the other cameras; and
a signal transmitter configured to transmit a signal indicating which camera obtained the presently displayed image.

8. The apparatus of claim 6, wherein the first controller is further configured to switch at least one of:
a color of the indicator,
a brightness of the indicator, and
an indication configuration, the indication configuration comprising on, off, and blinking.

9. The apparatus of claim 6, wherein the first controller is further configured to switch the indication of the indicator based on whether the apparatus operates in a low consumption power mode.

10. A control method of an indicator performed by an electric apparatus comprising one more cameras, the method comprising switching an indication of the indicator based on whether the camera is obtaining images and whether the apparatus recognizes a user's eye based on an image obtained by the camera.

11. The method of claim 10 further comprising recognizing the user's eye based on the image obtained by the camera and controlling an output direction of parallax images displayed on a display based on a position of the user's eye such that the parallax images displayed on the display are viewed stereoscopically.

12. The method of claim 10, further comprising switching the indication of the indicator based on the number of the cameras obtaining images among the one or more cameras, and whether the apparatus recognizes the user's eye based on the image obtained by the camera.

13. The method of claim 10, wherein switching the indication of the indicator, further comprises switching at least one of:
a color of the indicator,
a brightness of the indicator, and
an indication configuration, the indication configuration comprising on, off, and blinking.

14. The method of claim 10, further comprising switching the indication of the indicator based on whether the apparatus operates in a low consumption power mode.
